(19) United States
(12) Patent Application Publication
(10) Pub. No.: US 2016/0343240 A1
(43) Pub. Date: Nov. 24, 2016

(54) WARNING FIXATION DEVICE

(71) Applicant: NEIL CHUANG, New Taipei City (TW)

(72) Inventor: NEIL CHUANG, New Taipei City (TW)

(21) Appl. No.: 14/717,326

(22) Filed: May 20, 2015

(51) Int. Cl. G08B 25/12; G08B 25/01

(52) U.S. Cl. CPC G08B 25/12; G08B 25/016

(57) ABSTRACT

A warning fixation device is provided, including a main body and a fixation assembly. The main body includes a shell body and a warning assembly. The warning assembly is disposed in the shell body. The warning assembly selectively produces a warning signal. The fixation assembly includes a fixation portion and a rope member. The fixation portion is fixedly disposed on the shell body. The rope member is for being disposed on an article and assembled with the fixation portion. The rope member is extended to generate extra tension as assembled with the fixation portion to position the fixation portion.

### BACKGROUND OF THE INVENTION

1. Field of the Invention

The present invention relates to a warning device, and more particularly to a warning fixation device.

2. Description of the Prior Art

A warning device is such as disclosed in TW M494113. It at least includes a quick release fixation device, a warning device, a power source and a sensing device. The quick release fixation device is fixedly assembled to a bicycle body. The warning device is assembled to the quick release fixation device, and the warning device is connected with the sensing device through a signal transmission so that the warning device produces a warning signal.

However, a structure as described above is only assembled to the bicycle body (or other similar structures), and it is unable to be applied to such as shoe bodies. Besides, it has a large volume and is unable to wear to do exercises. Furthermore, an objective of the present invention is to increase convenience to wear the warning device.

The present invention has arisen to mitigate and/or obviate the afore-described disadvantages.

### SUMMARY OF THE INVENTION

The primary object of the present invention is to provide a warning fixation device. The warning fixation device is tied and fixed to the article and is applied widely; furthermore, it can include the electrical switch mechanism and produce intermittent said warning signal, it has a light and simple structure, and it is convenient to wear or remove; moreover, it can include a positioning structure and increase convenience and efficiency to tie and assemble, and it can further increase stability and solidity through the one cord/rope attaching feature of the assembly.

To achieve the above object, a warning fixation device in accordance with present invention includes a main body and a fixation assembly. The main body includes a shell body and a warning assembly. The warning assembly is disposed in the shell body. The warning assembly selectively produces a warning signal. The fixation assembly includes a fixation portion and a rope member. The fixation portion is fixedly disposed on the shell body. The rope member is for being disposed on an article and assembled with the fixation portion. The rope member is extended to generate extra tension as assembled with the fixation portion to position the fixation portion.

### BRIEF DESCRIPTION OF THE DRAWINGS

FIG. 1 is a perspective drawing of a first preferable embodiment of the present invention;

FIG. 2 is a perspective drawing of a main body of the first preferable embodiment of the present invention;

FIG. 3 is a breakdown drawing of the first preferable embodiment of the present invention;

FIG. 4 is another perspective drawing of the main body of the first preferable embodiment of the present invention;

FIG. 5 is a partial cross-sectional drawing of the first preferable embodiment of the present invention;

FIG. 6 is another partial cross-sectional drawing of the first preferable embodiment of the present invention;

FIG. 7 is a perspective drawing of a second embodiment of the present invention;

FIG. 8 is a perspective drawing of a third embodiment of the present invention;

FIG. 9 is a perspective drawing of a fourth embodiment of the present invention;

FIG. 10 is a perspective drawing of a main body of the fourth embodiment of the present invention;

FIG. 11 is a perspective drawing of a fifth embodiment of the present invention;

FIG. 12 is a perspective drawing of a sixth embodiment of the present invention;

FIG. 13 is a perspective drawing of a seventh embodiment of the present invention;

FIG. 14 is a perspective drawing of an eighth embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

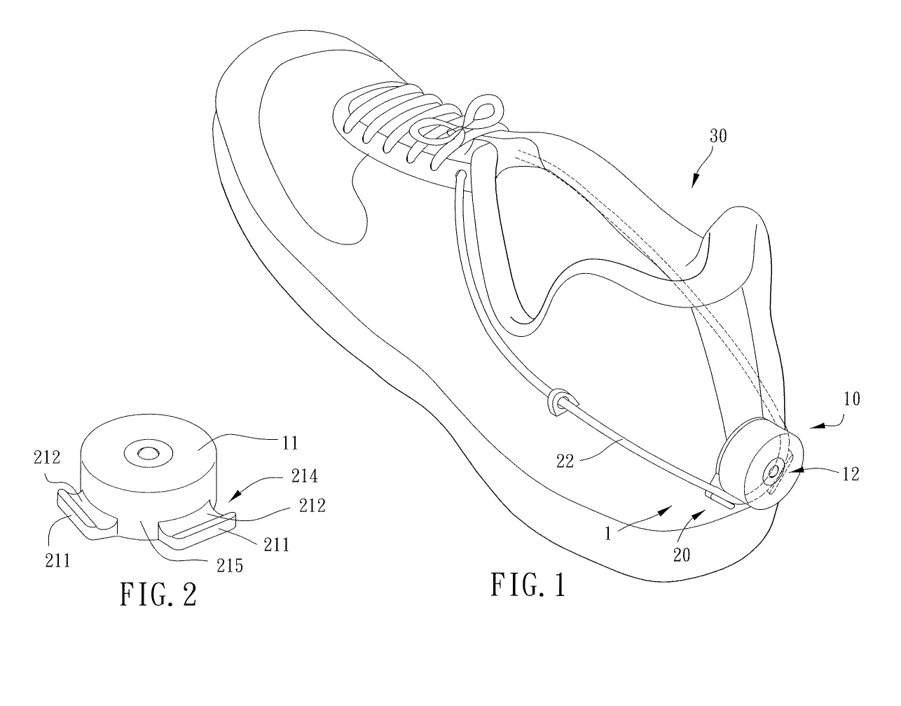

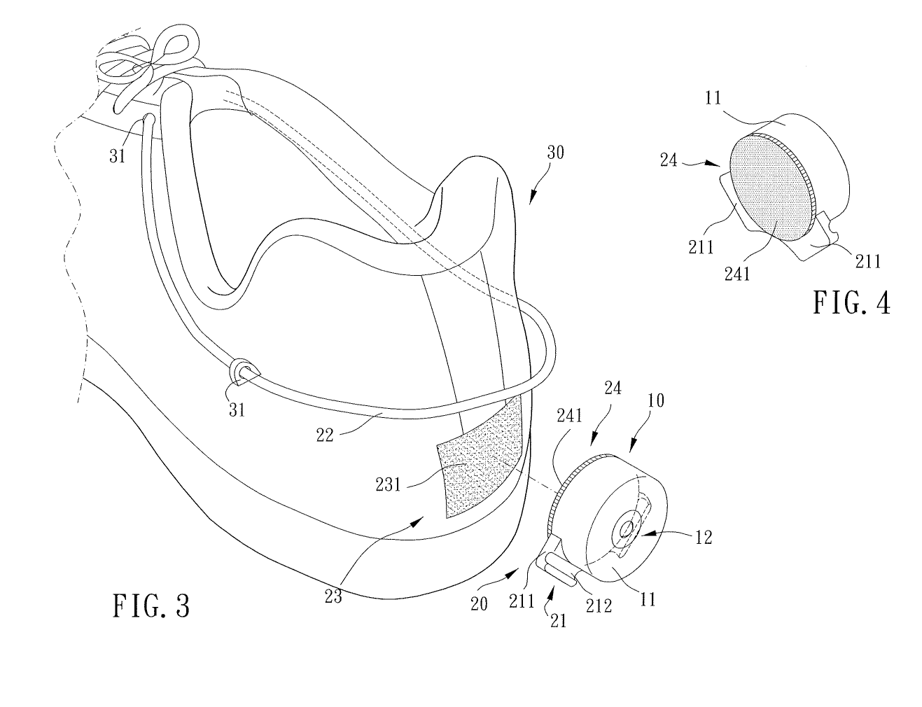

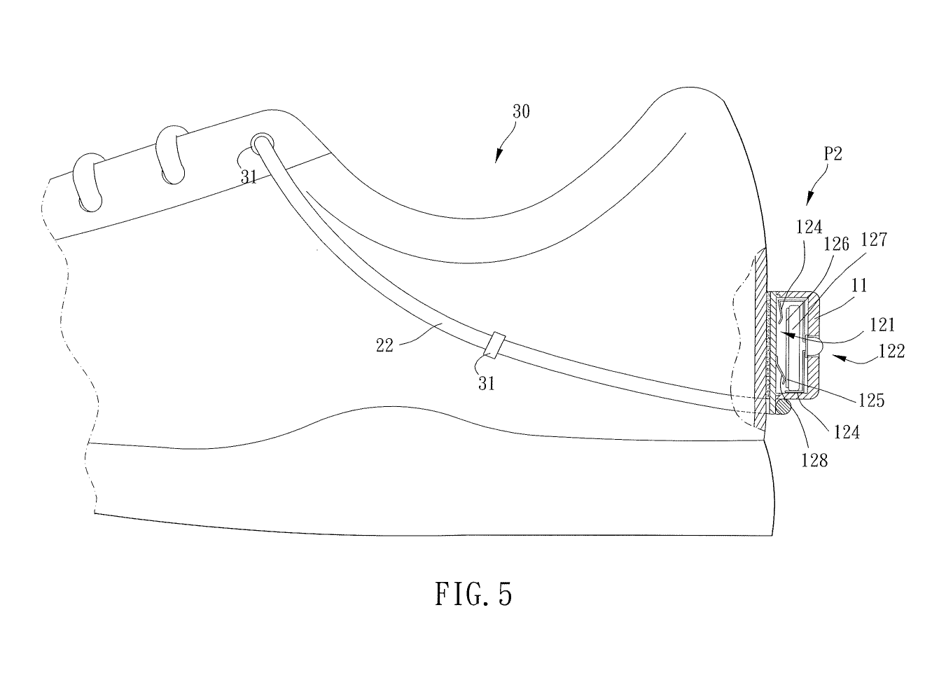

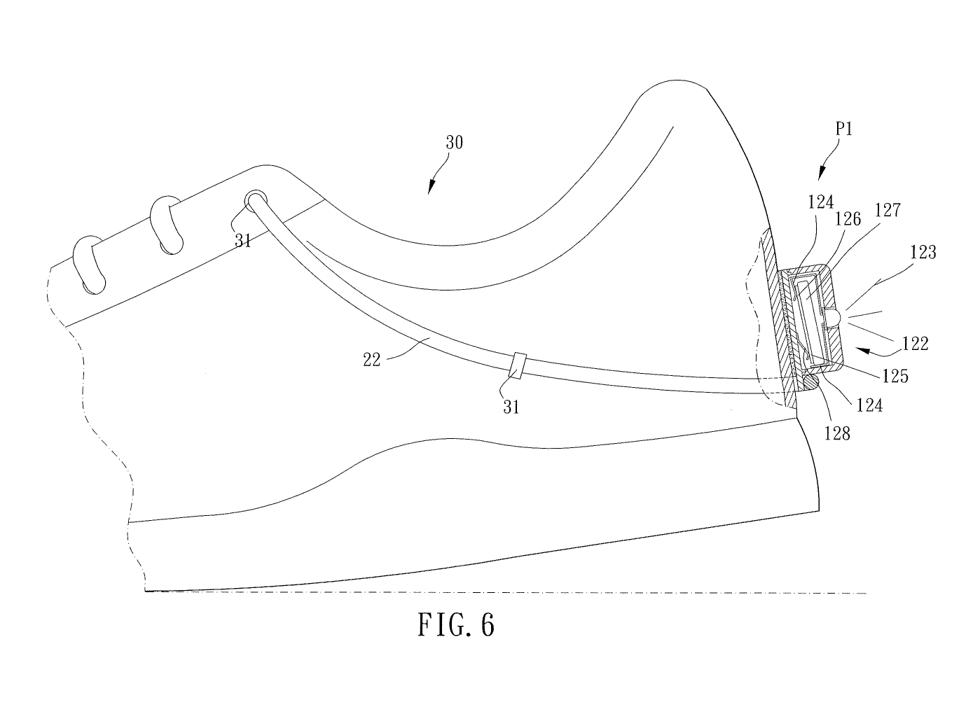

Please refer to FIGS. 1 to 6, a warning fixation device 1 in accordance with a first preferable embodiment of the present invention includes a main body 10 and a fixation assembly 20.

The main body 10 includes a shell body 11 and a warning assembly 12. The warning assembly 12 is disposed in the shell body 11. Furthermore, the warning assembly 12 includes an electrical switch mechanism 121 and a warning device 122 which is electrically connected with the electrical switch mechanism 121. Preferably, the electrical switch mechanism 121 is turned on and for being electrically connected with a power source via an inertia movement so that the warning device 122 produces a warning signal 123. Nevertheless, the electrical switch mechanism 121 can also be turned on via pressing by an external force, a centrifugal force movement or switching by hands.

The warning signal 123 can be a light signal or a voice signal. Specifically, the warning device 122 can include a LED lighting module, a buzzer or other similar members so that the warning device 122 can produce the light or voice warning signal 123. Nevertheless, the warning device 122 can also include a vibrator member so that the warning device 122 can produce a vibrating signal.

The fixation assembly 20 at least includes a fixation portion 21 and a rope member 22. The fixation portion 21 is fixedly disposed on the shell body 11. The rope member 22 is for being disposed on an article 30 and assembled with the fixation portion 21. The rope member 22 is extended to generate extra tension as assembled with the fixation portion 21 to position the fixation portion 21. For example, the rope member 22 is for fixedly disposed on the article 30. The fixation portion 21 includes at least one concave slot portion 214. The concave slot portion 214 is detachably assembled with the rope member 22. At least a portion of the rope member 22 is elastically abutted against the concave slot portion 214 for positioning assembling the shell body 11 to the article 30. The article 30 is such as a shoe body in the present embodiment. Nevertheless, in other embodiments, the article 30 can be a hat body, a cloth and so forth. The fixation portion 21 can include at least one wing portion 211 protrudingly extending from the shell body 11. Each wing portion 211 includes a fixation slot 212 assembled with the rope member 22. Specifically, in the present embodiment, the fixation portion 21 includes the two wing portions 211, and the two wing portions 211 are symmetrically disposed relative to the main body 10. For example, the two wing portions 211 are symmetrically disposed on two opposite sides of the main body 10. The shell body 11 includes a support portion 215 located between the two wing portions 211. The rope member 22 is detachably hitched on the two wing portions 211 and elastically abutted against the support portion 215 for positioning assembling the shell body 11 to the article 30. When the rope member 22 is assembled to the two fixation slots 212 of said wing portions 211, the rope member 22 further tightly ties the two wing portions 211 and is bendingly and elastically abutted against the support portion 215 so that the main body 10 is fixed on the article 30.

Moreover, the rope member 22 can penetrate through at least one fixation hole portion 31 disposed on the article 30 and wrap around the article 30 and the two wing portions 211 to fix the main body 10 to the article 30. And force is uniformly applied on the main body 10 when the main body 10 is tied on the article 30 because the two wing portions 211 are symmetric relative to the main body 10. It avoids that the force is nonuniformly applied on the main body 10 and the main body 10 easily falls off. The rope member 22 preferably includes elastic fibers or fabric fibers so that the rope member 22 has elasticity and toughness. And when the rope member 22 ties the fixation portion 21 and the article 30, the rope member 22 can deform with a predetermined deformation and is hard to break, and the rope member 22 provides a good performance in tightening.

The fixation assembly 20 further includes a first assembling portion 23 and a second assembling portion 24. The first assembling portion 23 is for being assembled to the article 30. The second assembling portion 24 is disposed on the shell body 11, and the first and second assembling portions 23, 24 are assembled to and positioned with each other. For example, in the present embodiment, the first and second assembling portions 23, 24 respectively include a first hook-and-loop fastener 231 and a second hook-and-loop fastener 241, and the first and second hook-and-loop fasteners 231, 241 are engageable with each other. The first and second hook-and-loop fasteners 231, 241 are such as Velcro fasteners. It is noted that the main body 10 can be positioned on the article 30 in advance through assembling the first and second assembling portions 23, 24, and then the fixation portion 21 is tied by the rope member 22. It is convenient and has good efficiency to assemble and tie the main body 10. Furthermore, the assembly of the first and second assembling portions 23, 24 can also increase stability and solidity of the assembly between the main body 10 and the article 30.

Practically, the electrical switch mechanism 121 includes two electrical connecting terminals 124. The two electrical connecting terminals 124 are connected with the warning device 122. One of the two electrical connecting terminals 124 is for being electrically connected with a first electrode 125 of the power source normally and the other is for being electrically connected to a second electrode 126 of the power source selectively. And when the two electrical connecting terminals 124 are electrically connected to the first and second electrodes 125, 126 of the power source, the warning device 122 produces the warning signal 123. In the present embodiment, the electrical switch mechanism 121 includes a battery member 127 which is swingable and a reposition device 128. The battery member 127 includes said first electrode 125 and said second electrode 126. Furthermore, one of the electrical connecting terminals 124 and the second electrode 126 are electrically connected via said inertia movement. For example, the reposition device 128 elastically abuts against a side of the battery member 127 so that the battery member 127 has a tendency to move toward a predetermined direction. The reposition device 128 is such as an elastic piece, a spring, a foam or other members with recoverability. Specifically, the reposition device 128 elastically abuts against an end of the battery member 127 adjacent to the first electrode 125. When the main body 10 is shacked, another end of the battery member 127 adjacent to the second electrode 126 swings and electrically contacts with the electrical connecting terminals 124 selectively. The battery member 127 is swingable between an on position P1 and an off position P2, and the reposition device 128 elastically abuts against the battery member 127 so that the battery member 127 has a tendency to move toward the off position P2. The warning assembly 12 has a light and simple structure. In other embodiments, the warning fixation device can further include a sensing member (not shown in Figs.). The sensing member is assembled on the main body. The sensing member and the warning assembly are electrically connected to each other. When the sensing member receives a sensing signal, the sensing member can drive the warning device to produce the warning signal.

The warning fixation device 1 can produce intermittent said warning signal 123 via a method as described above. For example, when a user wears the article 30 (such as the shoe body) and moves, the warning fixation device 1 produces the warning signal 123 during a movement. The electrical switch mechanism 121 is turned on via the inertia movement as described above and intermittent said warning signal 123 (such as flash light) is produced, and the user can carry the warning fixation device 1 at night. The warning fixation device 1 can be also applied on every moveable article to produce intermittent said warning signal 123. It is noted that the warning fixation device 1 can be also fixed to a hat, a cloth or other articles which the warning fixation device 1 can be tied thereto, and the warning fixation device 1 can be widely applied.

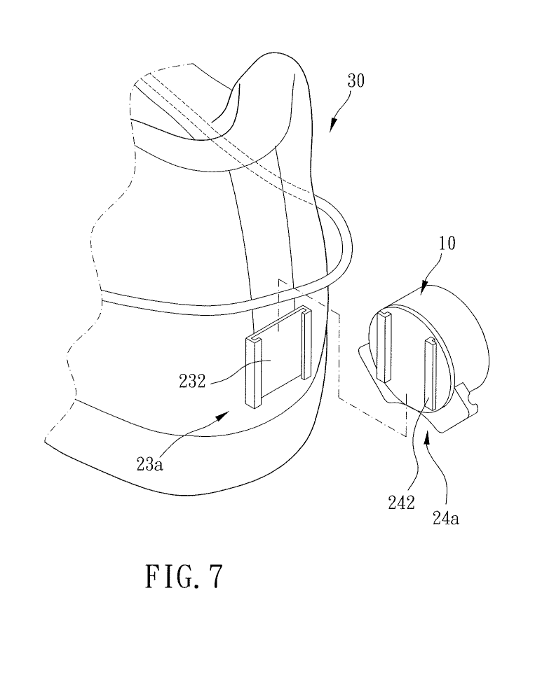

Please refer to FIG. 7, a second embodiment is provided. Compared with the embodiment as described above, one of a first assembling portion 23a and a second assembling portion 24a is provided with a slot portion 232 and the other is provided with a first hook portion 242. The first hook portion 242 is insertable into and engageable with the slot portion 232. For example, the first assembling portion 23a is provided with the slot portion 232 and the second assembling portion 24a is provided with the first hook portion 242 so that the main body 10 is positioned on the article 30 by assembling the first hook portion 242 and the slot portion 232.

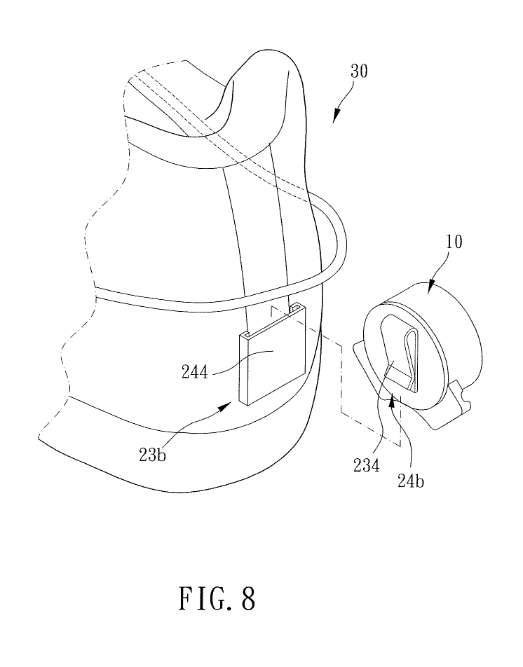

Please refer to FIG. 8, a third embodiment is provided. Compared with the embodiments as described above, one of a first assembling portion 23b and a second assembling portion 24b is provided with a second hook portion 234 and the other is provided with a clasp portion 244, and the second hook portion 234 and the clasp portion 244 are engageable to each other. For example, the first assembling portion 23b is provided with the clasp portion 244 and the second assembling portion 24b is provided with the second hook portion 234 so that the main body 10 is positioned on the article 30 by assembling the second hook portion 234 and the clasp portion 244.

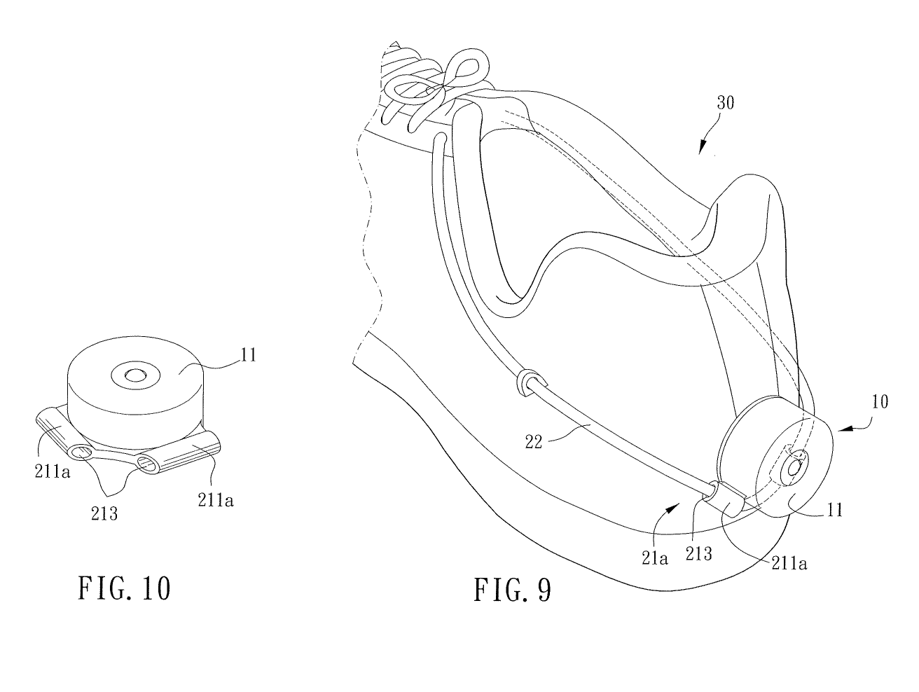

Please refer to FIGS. 9 and 10, a fourth embodiment is provided. Compared with the embodiments as described above, a fixation portion 21a includes at least one wing portion 211a protrudingly extending from the shell body 11. For example, the fixation portion 21a includes the two wing portions 211a. Each wing portion 211a includes a through hole 213, and the rope member 22 penetrates through the two through holes 213 and the main body 10 is tied and fixed to the article 30 by the rope member 22.

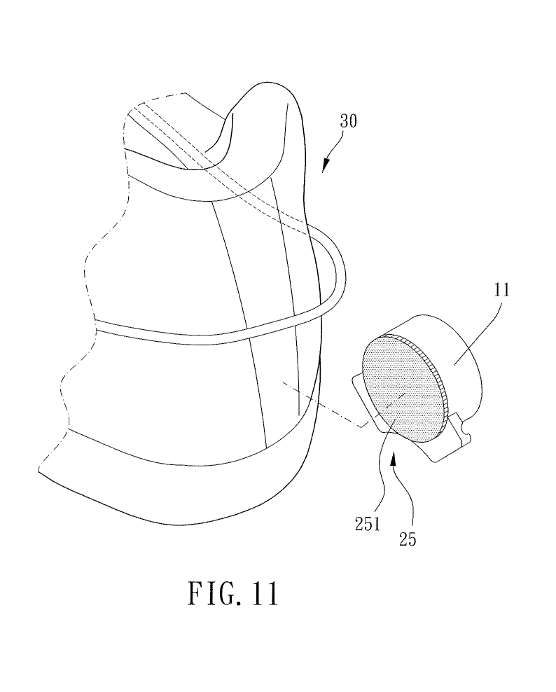

Please refer to FIG. 11, a fifth embodiment is provided. Compared with the embodiments as described above, a fixation assembly 20a includes an assembling portion 25. The assembling portion 25 is disposed on the shell body 11. The assembling portion 25 is for being tightly abutted against and positioned on the article 30. For example, the assembling portion 25 includes an adhesive portion 251. The adhesive portion 251 is for being tightly abutted against the article 30. Preferably, the adhesive portion 251 can include silicone gel or rubber so that the adhesive portion 251 can position on a surface of the article 30.

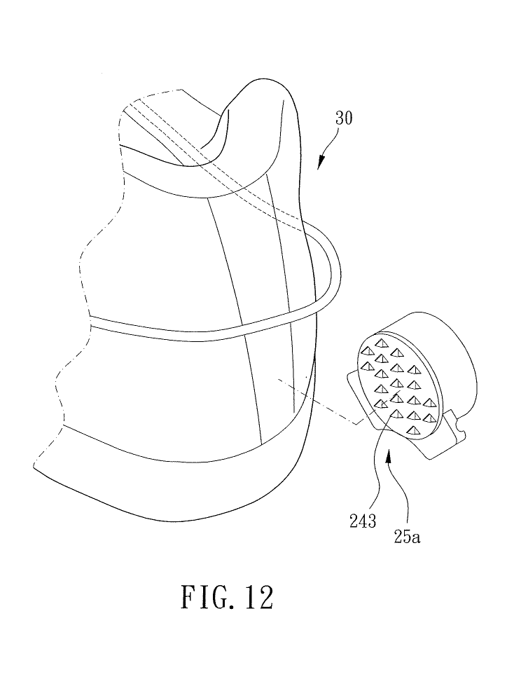

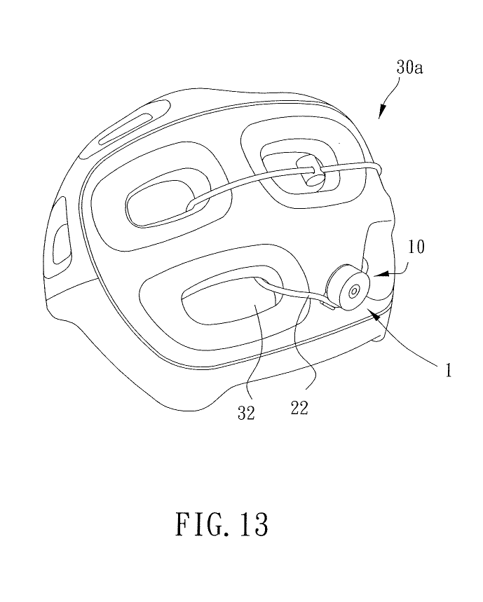

Please refer to FIG. 12, a sixth embodiment is provided. Compared with the embodiments as described above, an assembling portion 25a includes a spine portion 243. The spine portion 243 is for being engageably abutted against the surface of the article 30 so that the assembling portion 25a can also position on the article 30. Please refer to FIG. 13, a seventh embodiment is provided. Compared with the embodiments as described above, the warning fixation device 1 is assembled to a bicycle helmet 30a. The bicycle helmet 30a is provided with a plurality of through holes 32 so that the rope member 22 penetrates the through holes 32 and ties the main body 10 to the bicycle helmet 30a. And a user can assemble the warning fixation device 1 to the bicycle helmet 30a when the user rides a bicycle.

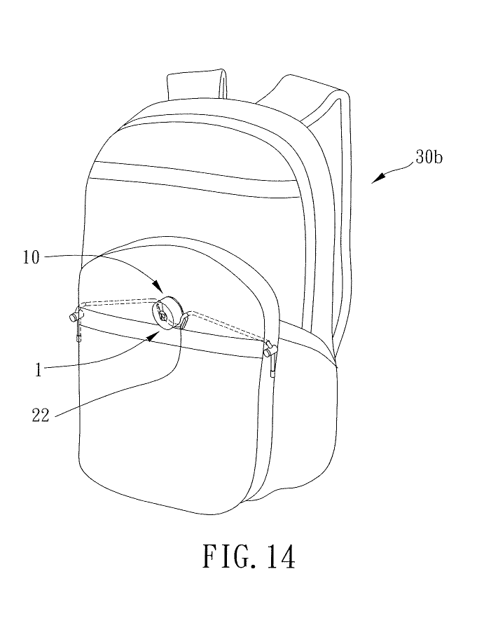

Please refer to FIG. 14, an eighth embodiment is provided. Compared with the embodiments as described above, the warning fixation device 1 is assembled to a knapsack 30b. The rope member 22 penetrates through the knapsack 30b and ties the main body 10 to the knapsack 30b.

As a conclusion, the warning fixation device of the present invention is tied and fixed to the article and is applied widely; furthermore, it can include the electrical switch mechanism and produce intermittent said warning signal, it has a light and simple structure, and it is convenient to wear; moreover, it can include a positioning structure and increase convenience and efficiency to tie and assemble, and it can further increase stability and solidity of the assembly.

While we have shown and described various embodiments in accordance with the present invention, it should be clear to those skilled in the art that further embodiments may be made without departing from the scope of the present invention.

What is claimed is:

1. A warning fixation device, comprising:
a main body, including a shell body and a warning assembly, the warning assembly disposed in the shell body, the warning assembly selectively producing a warning signal;
a fixation assembly, including a fixation portion and a rope member, the fixation portion fixedly disposed on the shell body, the rope member for being disposed on an article and assembled with the fixation portion, the rope member extended to generate extra tension as assembled with the fixation portion to position the fixation portion.

2. The warning fixation device as claimed in claim 1, wherein the rope member is for being fixedly disposed on the article, the fixation portion includes at least one concave slot portion, the concave slot portion is detachably assembled with the rope member, and at least a portion of the rope member is elastically abutted against the concave slot portion for positioning and assembling the shell body to the article.

3. The warning fixation device as claimed in claim 1, wherein the fixation portion includes at least one wing portion protrudingly extending from the shell body, and each wing portion includes a fixation slot assembled with the rope member.

4. The warning fixation device as claimed in claim 3, wherein the fixation portion includes two said wing portions protrudingly extending from the shell body, the shell body includes a support portion located between the two wing portions, and the rope member is detachably hitched on the two wing portions and elastically abutted against the support portion for positioningly assembling the shell body to the article.

5. The warning fixation device as claimed in claim 1, wherein the fixation portion includes at least one wing portion protrudingly extending from the shell body, each wing portion includes a through hole, and the rope member penetrates through at least one said through hole.

6. The warning fixation device as claimed in claim 1, wherein the fixation assembly further includes a first assembling portion and a second assembling portion, the first assembling portion is for being assembled to the article, the second assembling portion is disposed on the shell body, and the first and second assembling portions are assembled to and positioned with each other.

7. The warning fixation device as claimed in claim 6, wherein the first and second assembling portions respectively include a first hook-and-loop fastener and a second hook-and-loop fastener, and the first and second hook-and-loop fasteners are engageable with each other.

8. The warning fixation device as claimed in claim 6, wherein one of the first and second assembling portions is provided with a slot portion and the other is provided with a first hook portion, and the first hook portion is insertable into and engageable with the slot portion.

9. The warning fixation device as claimed in claim 6, wherein one of the first and second assembling portions is provided with a second hook portion and the other is provided with a clasp portion, and the second hook portion and the clasp portion are engageable to each other.

10. The warning fixation device as claimed in claim 1, wherein the fixation assembly further includes an assembling portion, the assembling portion is disposed on the shell body, and the assembling portion is for being tightly abutted against and positioned on the article.

11. The warning fixation device as claimed in claim 10, wherein the assembling portion includes a spine portion, and the spine portion is for being engageably abutted against the article.

12. The warning fixation device as claimed in claim 10, wherein the assembling portion includes an adhesive portion, and the adhesive portion is for being tightly abutted against the article.

13. The warning fixation device as claimed in claim 12, wherein the adhesive portion includes silicone gel or rubber.

14. The warning fixation device as claimed in claim 1, further including a sensing member, wherein the sensing member is assembled on the main body, and the sensing member and the warning assembly are electrically connected to each other.

15. The warning fixation device as claimed in claim 1, wherein the warning signal is a light signal or a voice signal.

16. The warning fixation device as claimed in claim 1, wherein the warning assembly includes an electrical switch mechanism and a warning device electrically connected with the electrical switch mechanism, the electrical switch mechanism includes two electrical connecting terminals, the two electrical connecting terminals are connected with the warning device, one of the two electrical connecting terminals is for being electrically connected with a first electrode of a power source normally and the other is for being electrically connected to a second electrode of the power source selectively, and when the two electrical connecting terminals are electrically connected to the first and second electrodes of the power source, the warning device produces the warning signal.

17. The warning fixation device as claimed in claim 16, wherein the electrical switch mechanism includes a battery member which is swingable, the battery member includes the first electrode and the second electrode, one of the electrical connecting terminals and the second electrode are electrically connected via an inertia movement, wherein the battery member is swingable between an on position and an off position, the electrical switch mechanism further includes a reposition device, and the reposition device elastically abuts against a side of the battery member so that the battery member has a tendency to move toward the off position.
